(19) United States
(12) Patent Application Publication
(10) Pub. No.: US 2018/0245336 A1
(43) Pub. Date: Aug. 30, 2018

(54) FLAME-RETARDANT, FIREPROOF, SEMI-INCOMBUSTIBLE PLYWOOD CEILING MATERIAL, AND METHOD FOR MANUFACTURING SAME

(71) Applicant: INDUSTRIAL COOPERATION FOUNDATION CHONBUK NATIONAL UNIVERSITY, Jeonju-si (KR)

(72) Inventor: Heejun PARK, Jeonju-si (KR)

(73) Assignee: INDUSTRIAL COOPERATION FOUNDATION CHONBUK NATIONAL UNIVERSITY, Jeonju-si (KR)

(21) Appl. No.: 15/753,458

(22) PCT Filed: Aug. 18, 2016
(86) PCT No.: PCT/KR2016/009089

§ 371 Date: Feb. 19, 2018

(30) Foreign Application Priority Data
Aug. 20, 2015 (KR) 10-2015-0117037

(51) Int. Cl. E04B 1/94; B32B 3/26; B32B 21/08; B32B 21/14; B27K 3/36; B27K 3/08; E04C 2/12

(52) U.S. Cl. CPC E04B 1/942; B32B 3/266; B32B 21/08; B32B 21/14; B27K 3/36; E04B 2103/04; E04C 2/12; B32B 2307/3065; B32B 2419/00; B27K 2240/30; B27K 3/08

(57) ABSTRACT

The present invention relates to a fireproof, semi-incombustible ceiling material manufactured by perforating plywood and then pressure-injecting a flame-retardant or fireproof resin in a vacuum state, and to a method for manufacturing same. In the present invention, a fireproof resin may be injected in a short period of time along the fiber direction of wood through a hole perforated in plywood to minimize the stress applied to an adhesion layer. Moreover, shrinkage stress generated during drying due to reduced drying time may be reduced. Thus, since the inside of plywood can be impregnated with a fireproof resin in an amount sufficient to meet standards for fire safety, the present invention may provide a fireproof, semi-incombustible wood-based ceiling material. In addition, the ceiling material of the present invention utilizes pre-manufactured plywood, and is thus lightweight and high-strength, and may replace, in particular, asbestos-containing inorganic ceiling materials (gypsum board, etc.), which emit radon radiation and have poor resistance to humidity and moisture. Moreover, the ceiling material of the present invention uses wood-based plywood, and thus controls temperature and humidity, preserves beautiful natural wood grain patterns and coloring, and contributes to the improvement of indoor environments. Furthermore, the ceiling material of the present invention may manufacture a ceiling material having a uniform, plate-like structure with excellent dimensional stability, which is difficult to manufacture using wood.

### TECHNICAL FIELD

The present disclosure relates to flame-retardant, incombustible and quasi-noncombustible ceiling materials and manufacturing methods thereof, more particularly flame-retardant, incombustible and quasi-noncombustible ceiling materials manufactured by simply applying flame-retardant or incombustible resin on the surface of plywood as one of the representative wooden platy materials to permeate the resin into the surface or by perforating the surface of the plywood and then injecting under pressure the incombustible resin in the formed hole in vacuum and manufacturing methods thereof.

### DESCRIPTION OF THE BACKGROUND ART

Ceiling materials for the interior of an architectural structure are construction materials installed on the ceiling of a structure of public facilities such as schools, hospitals, hotels, shopping arcades in order to shield the substructure under the roof which refers to the interior of the wall on the opposite side of the roof and the floor structure of its higher stories.

Such ceiling materials also hide the pipes, cables and the like installed in a structure or its ceiling, is used for independent decoration and shut out, absorb and reflect to a certain extent rain and wind, heat, sound and the like.

In the meantime, the laws and regulations related to fire safety including the Enforcement Decree of the Construction Act, the Rules for Criteria for Evacuation and Fire Protection Structure of Buildings, and the Special Act for Safety Control of Public Businesses provide that materials with flame-retardancy, incombustibility and quasi-noncombustibility performance or higher shall be used for interior decoration or interior finishing depending upon sites of use and areas of use in order to prevent flames from spreading through such ceiling materials in the event of fire.

However, it is very difficult up to this point to manufacture ceiling materials with flame-retardancy, incombustibility and quasi-noncombustibility performance or higher using plywood, particleboard, medium-density fiberboard (MDF) and the like as representative wooden materials made of wood.

For instance, particleboard and MDF are not very favorable to ceiling materials taking into consideration their drawbacks including heavy weight, poor dimensional stability, vulnerability to fire and the like because of the fact that they are manufactured in the mode of thermocompression up to high density.

FIG. 1 shows the structure of plywood as one of the representative wooden platy materials. Referring to FIG. 1, plywood means a wide plate material manufactured by slicing wood into thin plates, or in other words, veneers and stacking up and bonding together an odd number of the veneers so that their directions of fiber arrangement intersect each other orthogonally. Plywood has advantages including wood grains, texture, sound absorption, temperature and humidity regulation, high strength, difficulty to cause cleavage or deformation and the like which are inherent to wood and, at the same time, dimensional stability superior to that of wood, which accounts for the fact that plywood can be manufactured into materials with a very large width, which are hard to manufacture by using wood.

Although manufacturing incombustible plywood by incombustibility-treating veneers, drying the veneers and stacking up and bonding together the veneers has been thus far attempted, issues are still posed such as cumbersomeness in handling, high fault rate in manufacturing, high manufacturing costs and relatively low improvement of incombustibility in spite of incombustibility treatment because a sheet of the veneer is very thin. As a result, actually no flame-retardant and incombustible plywood is manufactured and distributed presently in Korea.

### SUMMARY OF THE DISCLOSURE

The present disclosure relates to manufacturing plywood ceiling materials which meet the criteria for flame-retardancy, incombustibility and quasi-noncombustibility performance set forth in the related laws and regulations and can be used for the superior ceiling materials.

The present disclosure provides the ceiling materials having flame-retardancy, incombustibility and quasi-noncombustibility performance through the simple manufacturing methods with lowered unit manufacturing cost.

An aspect according to the present disclosure provides a manufacturing method of the flame-retardant plywood ceiling material including: drying and polishing the surface of the manufactured plywood; applying the previously determined incombustible resin on the surface of the plywood; and letting the applied resin permeate the surface layer of the veneers and be dried, wherein the dried plywood meets the criteria for flame-retardancy performance.

An aspect according to the present disclosure provides a manufacturing method of the incombustible and quasi-noncombustible plywood ceiling material including:
perforating the surface of the plywood to form a plurality of the holes;
transferring the perforated plywood to a vacuum chamber;
injecting the incombustible resin into the inside of the vacuum chamber by reducing pressure inside the vacuum chamber, thereby keeping the inside of the vacuum chamber in vacuum;
infiltrating the incombustible resin into the plywood by applying a certain degree of pressure into the vacuum chamber filled with the incombustible resin; and
drying the plywood infiltrated with the resin.

An aspect according to the present disclosure provides the incombustible and quasi-noncombustible ceiling material including:
the plywood having a plurality of the holes; and
the incombustible resin infiltrated into the inside of the plywood through the holes.

The present disclosure relates to manufacturing the flame-retardant plywood which conforms with the criteria for flame-retardancy performance and can have a flame-retardancy certificate approved by related criteria by applying the previously determined flame-retardant and incombustible resin on the surface of the plywood, infiltrating the surface layer with the resin and drying the surface.

According to the present disclosure, it is possible to minimize swelling stress exerted on a bonding layer because the incombustible resin can be injected in a short time in the direction of fiber arrangement of each layer of the veneers through the holes formed in the plywood and to reduce shrinkage stress because drying time decreases. Therefore, the present disclosure can provide the wooden incombustible and quasi-noncombustible ceiling materials by infiltrating the incombustible resin in adequate quantity into the inside of the plywood so that the materials conform with the fire safety criteria.

The ceiling materials according to the present disclosure are lightweight and have high strength because they employ the plywood previously manufactured and, in particular, can replace inorganic ceiling materials such as gypsum board, which contain asbestos, radiate radon radioactivity and are vulnerable to humidity and water.

In addition, the ceiling materials provided by the present disclosure can regulate temperature and humidity and maintain beautiful and natural wood grains and colors because they employ the plywood made of wood and can provide superior sound-absorbing effects because they have a plurality of the holes.

Moreover, the present disclosure can provide the platy ceiling materials with a very large width which are homogenous and have good dimensional stability, which are hard to manufacture by using wood.

### BRIEF DESCRIPTION OF THE SEVERAL VIEWS OF THE DRAWING

FIG. 1 shows the structure of the plywood.

FIGS. 2 and 3 are flowcharts describing the manufacturing methods of the ceiling materials according to the present disclosure.

FIG. 4 illustrates the ceiling material manufactured by the method of FIG. 2 according to the present disclosure.

FIG. 5 is a cross-sectional view showing that the holes are formed through the ceiling material.

FIG. 6 is a cross-sectional view showing that the holes are formed down to a previously determined depth.

FIG. 7 illustrates an example of a loading device which can be used for the present disclosure.

FIGS. 8 and 9 show methods for pressurizing the incombustible resin according to the present disclosure.

FIG. 10 shows the plywood ceiling material manufactured according to Embodiment 1, (a) and a construction example of the ceiling material of (a) adhered to the ceiling, (b).

### DETAILED DESCRIPTION OF THE DISCLOSURE

The present disclosure can be achieved completely by description below. The description below should be construed as explaining desirable and specific examples of the present disclosure but is not necessarily limited thereto.

Embodiments according to the present disclosure will be described in more detail hereinafter with reference to the accompanying drawings.

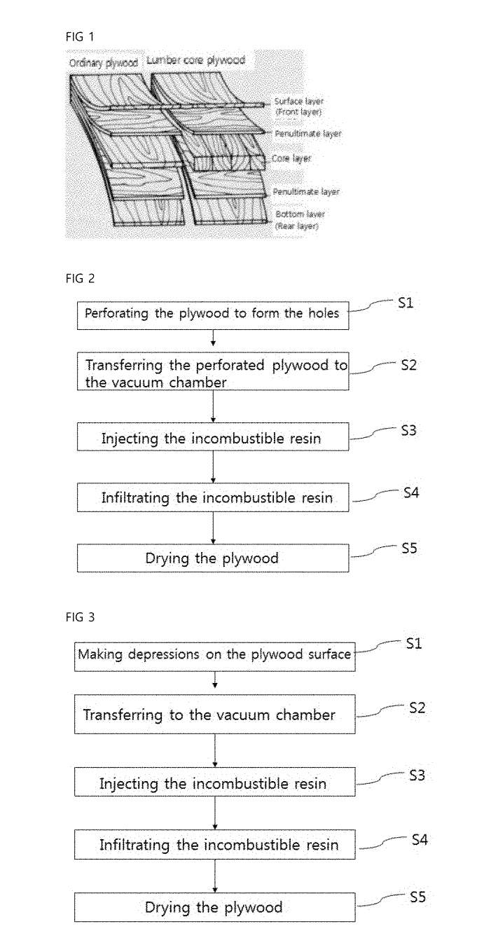

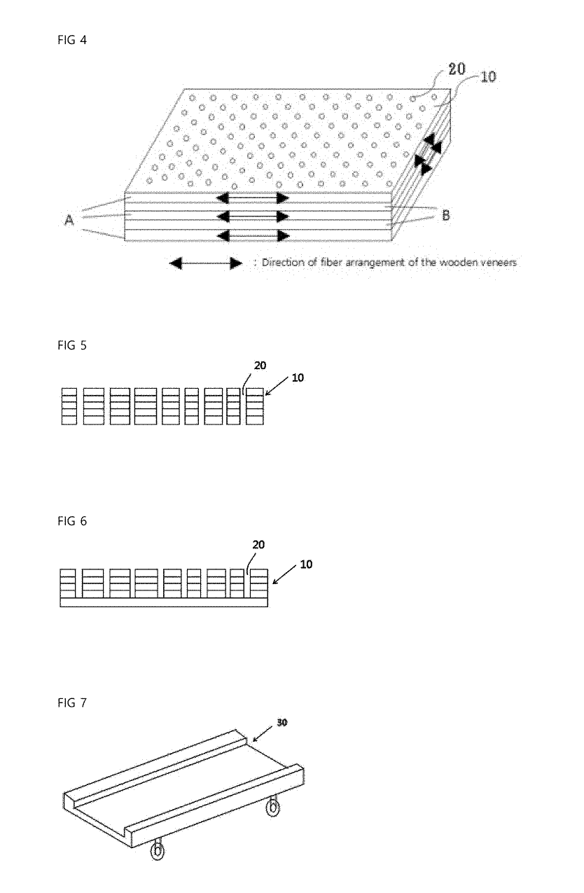

FIGS. 2 and 3 are flowcharts describing the manufacturing methods of the ceiling materials according to the present disclosure. FIG. 4 illustrates the ceiling material manufactured by the method of FIG. 2 according to the present disclosure. FIG. 5 is a cross-sectional view showing that the holes are formed through the ceiling material while FIG. 6 is a cross-sectional view showing that the holes are formed down to a previously determined depth.

Referring to FIG. 2, the present disclosure provides the manufacturing method of the incombustible and quasi-noncombustible ceiling materials including:

the perforating the plywood to form the holes S1;

the transferring the plywood to the vacuum chamber S2;

the generating vacuum and the injecting the resin S3;

infiltrating the resin S4; and

the drying the plywood S5.

The perforating S1 is a step of perforating the plywood to form the holes.

The perforating is the step of perforating the plywood to form the holes having a predetermined size. The holes can be formed to penetrate through the plywood. In addition, in the step of perforating, the holes can have a depth of one fourth, desirably a half, or more of the thickness of the plywood.

In the step of perforating, the holes can have a diameter of 1 to 10 mm and be formed at an interval of 30 to 100 mm in between. The holes can be formed by unrestrictedly using a well-known screw.

Referring FIGS. 4 through 6, a plurality of the holes 20 are formed in the plywood 10.

Referring FIG. 4, the veneers A and the veneers B are bonded together so that their directions of fiber arrangement intersect each other orthogonally. An adhesive layer exists between the veneers so as to bond the veneers together.

Referring to FIGS. 5 and 6, the holes 20 penetrate through the plywood or are formed down to one fourth or more of the thickness of the plywood. The holes 20 provide a route through which the incombustible resin is injected and injected again under pressure towards the flank of each of the veneers, in other words, in the direction of the fiber of each layer of the veneers.

Meanwhile, injecting the incombustible resin can be facilitated by making depressions on the surface of the plywood. The depressions can be formed by boring repeatedly the hole with a predetermined diameter down to a predetermined depth across the whole of the surface of the plywood. For example, the holes with a diameter of 2 to 6 mm can be bored down to from 1 to 3 mm at an interval of several millimeters to several centimeters across the whole of the surface of the plywood. In this method, the incombustible resin can be forcibly injected through the holes and sound-absorbing performance can be enhanced due to the holes.

The transferring the plywood S2 is a step of loading the perforated plywood onto the loading device 30 and transferring the plywood to the vacuum chamber. Any device which can carry and secure the plywood can be unrestrictedly used for the loading device 30. FIG. 7 illustrates an example of the loading device which can be used for the present disclosure.

The transferring the incombustible resin or the flame-retardant resin (both will be designated the incombustible resin hereinafter) to the vacuum chamber S3 is a step of injecting the incombustible resin by reducing pressure inside the vacuum chamber, thereby keeping the inside of the vacuum chamber in vacuum.

In the step S3, the incombustible resin is injected after establishing a vacuum state inside the vacuum chamber. The degree of vacuum inside the vacuum chamber can be lower than the atmospheric pressure (760 mmHg).

In the step of injecting the resin, the resin can be transferred from an agent tank more rapidly to the vacuum chamber while the resin can be injected into the inside of the plywood in a larger quantity when a vacuum state is established inside the vacuum chamber. According to the present disclosure, air and water contained in the tank and the plywood are removed as much as possible by holding a vacuum state for a certain period before pressure is applied because it is difficult to inject an agent adequately even under high external pressure when air and water are contained in the intercellular cavities and space and the like in the wooden veneer. In this regard, an adequate quantity of such agents can be injected within a short time by removing air and water from the inside of wood at a sufficient degree of vacuum before the agent is pressurized.

The infiltrating the incombustible resin into the plywood S4 is a step of forcibly injecting the incombustible resin into the plywood by applying a certain degree of pressure into the vacuum chamber filled with the resin. In the infiltrating S4, the incombustible resin is forcibly injected into wood by operating a booster pump when the vacuum chamber is completely filled with the incombustible resin.

The incombustible resin should be injected in a predetermined quantity (400 kg/m³) or more for a long period for manufacturing the plywood having incombustibility and quasi-noncombustibility performance. However, because the plywood has the bonding layers (adhesive membranes) formed between the veneers, it is difficult to inject the agent due to the bonding layers when pressure is applied for a long period in order to inject the agent in a large quantity while the bonding layers can be destroyed if shrinkage stress is generated when the incombustible resin is injected and dried. In other words, the plywood can lose its commercial value because a very long time is required for injecting the resin and the veneers can be separated due to destruction of the bonding layers when the plywood goes through pressurization and injection according to the same method as general wood.

FIGS. 8 and 9 show methods for injecting, by pressurizing, the incombustible resin according to the present disclosure. Referring FIGS. 8 and 9, the incombustible resin 40 is rapidly injected into the inside of the plywood through the holes bored in the plywood and can be simultaneously injected towards the flank of each of the veneers, in other words, in the direction of the fiber of the wood veneer thereafter.

According to the present disclosure, the incombustible resin is infiltrated into all the veneers at once, instead of consecutively from the upper ones down to the lower ones. In addition, the present disclosure has an advantageous effect of a very large infiltration rate because the incombustible resin can be injected in the direction of the fiber of the veneer wood and another advantageous effect that a predetermined quantity of the resin can be infiltrated. Moreover, according to the present disclosure, any impact upon adhesion performance of the bonding layers can be minimized in that the incombustible resin is injected neither through nor across the bonding layers. That is to say, the methods the present disclosure provides do not generate separation (or detachment) of the veneers because swelling stress exerted on the bonding layers can be minimized and shrinkage stress can also be reduced due to reduced drying time.

In step of infiltrating S4 according to the present disclosure, pressure and time can be arbitrarily established depending on thickness and type of the plywood, composition of the resin and criteria for incombustibility, quasi-noncombustibility, noncombustibility and the like.

In the step of infiltrating according to the present disclosure, the pressure is over 10 kg/cm², desirably 15 kg/cm² or more, and, to increase productivity, can be 20 kgf/cm² or more. When the pressure in the step of infiltrating is 15 kg/cm² or below, it is difficult to inject the incombustible resin in a reference amount or more into the plywood while a long time is required for injecting the resin in a predetermined amount or more.

In the step of pressurizing, a pressure over 10 kg/cm², desirably over 15 kg/cm², can be intermittently applied at a predetermined interval on the booster pump so as to continuously keeping the pressure at 10 kg/cm², desirably 15 kg/cm² or more.

When an appropriate amount of the resin is infiltrated into the plywood, the resin remaining in the vacuum chamber is recovered by operating a pump and the plywood is transferred to a dryer.

The drying S5 is a step of drying the plywood infiltrated with the resin.

The drying is a step of removing water infiltrated, together with the resin, into the plywood through evaporation.

As water evaporates in the step of drying, a flame retardant contained as aqueous solution in internal space of the plywood in the step of infiltrating remains in and fills the internal space as solid. The drying is a step of drying the plywood by controlling temperature, humidity and air flow rate inside the dryer. In the step of drying, the plywood can be artificially dried at a low temperature of 100° C. or below. For example, the plywood can be dried at over 40° C. and at 100° C. or below, desirably at 60 to 80° C. or below.

As water evaporates in the step of drying, components (the flame retardant, water-soluble glycols and other additives) of the incombustible resin remain as (resin) solid.

In the step of infiltrating, a water-soluble phosphorus-based flame retardant which fills the holes is removed in the process that the residual resin is recovered in the vacuum chamber and during the step of drying leaving the formed holes.

The incombustible resin which can be used for the present disclosure includes water, water-soluble flame retardants and water-soluble glycols.

The water-soluble glycols which can be used for the present disclosure include ethylene glycol, diethylene glycol, triethylene glycol, tetraethylene glycol, trimethylene glycol, propylene glycol, butanediol, pentanediol, neopentyl glycol, hexamethylene glycol, decamethylene glycol and the like and are desirably ethylene glycol. In addition, polymer resins can be selected as the water-soluble glycols including polyethylene glycol, polyethylene glycol (meth)acrylate, polyethylene glycol diacrylate, diethylene glycol diglycidyl ether, polypropylene glycol (meth)acrylate and the like. The water-soluble glycols desirably have a molecular weight of 1,000 or less, more desirably 500 or less.

The water-soluble glycols can prevent the water-soluble flame retardant from evaporating, soften wood and improve dimensional stability of wood by being infiltrated into wood and act as anti-freezing agent which prevents the water-soluble flame retardant from being frozen in winter.

The incombustible resin for being infiltrated into wood can include 1 to 10, desirably 1 to 3, parts by weight of the water-soluble glycols for 100 parts by weight of water.

At least one of a guanidine-based flame retardant and the phosphorus-based flame retardant can be used for the water-soluble flame retardant.

The phosphorus-based flame retardant can be a phosphorus polymer which has carbon atoms. The phosphorus-based flame retardants can be phosphoric acid, ammonium phosphates, ammonium polyphosphates, phosphorus-based polymers, urea phosphates, urethane phosphate compounds or phosphate compounds. The phosphoric acid is used for dissolving the phosphorus-based flame retardant instead of for incombustibility performance.

Guanidine, guanidine sulfamate, guanidine phosphates and the like can be used as the guanidine-based flame retardant.

The phosphorus-based flame retardant as polymer into which phosphorus and nitrogen are combined with each other has high adhesive strength, becomes easily cross-linked and has high incombustibility. The phosphorus-based flame retardant having carbon atoms exerts no influence on adhesion, painting and appearance because it is dried inside and adhered to infinitesimal cavities such as the intercellular lumens, the intercellular space and the like inside wood and doesn't bring about whitening even when it remains on the surface of wood.

A guanidine phosphate compound is formed when part of the mixed phosphorus-based flame retardant and guanidine-based flame retardant.

The guanidine phosphate compound is adsorbed inside infinitesimal cavities in paper.

Therefore, the guanidine phosphate compound neither causes whitening nor decreases adhesion even when it remains on the surface of paper.

The incombustible resin can include 1 to 10 parts by weight of phosphorus, 5 to 45 parts by weight of ammonium (poly)phosphate and 1 to 3 parts by weight of ethylene glycol for 100 parts by weight of water.

The incombustible resin can include 10 to 100 parts by weight of the phosphorus-based flame retardant, 5 to 45 parts by weight of the guanidine-based flame retardant and 1 to 10 parts by weight of the water-soluble ethylene glycol for 100 parts by weight of water.

The incombustible resin can include 1 to 10 parts by weight of phosphorus, 10 to 99 parts by weight of ammonium phosphate, 5 to 45 parts by weight of guanidine and 1 to 10 parts by weight of the water-soluble ethylene glycol for 100 parts by weight of water.

The incombustible resin can additionally include at least one auxiliary agent among phosphorus-based polymers having carbon atoms, urethane flame retardants, melamine, acrylic dispersing agents, guanidine sulfamate and urea.

The phosphorus-based polymer includes carbon atoms and can be at least one selected among a group composed of phosphate compounds, polyurethane phosphate compounds, ethylenediamine phosphate, cyclic phosphate, dimethylethyl phosphate, diethyl phosphate, dimethyl (methyl) phosphonate and triethyl phosphate.

The incombustible resin according to the present disclosure can include other additives.

One to 10 parts by weight of mycostats, antiseptics, stains, aromatic agents and the like as the other additives can be additionally included for 100 parts by weight of water. Furthermore, inorganic components which can perform humidity regulation can be included such as porous alumina, silica gel, calcium chloride and the like.

An aspect according to the present disclosure relates to the plywood ceiling material.

Referring to FIG. 4, the ceiling material provided by the present disclosure includes:

the plywood 10 having a plurality of the holes 20 or the depressions on the surface; and

the incombustible resin infiltrated into the inside of the plywood through the holes.

The holes bored in the ceiling material can have a diameter of 1 to 10 mm, being formed at an interval of 30 to 100 mm in between down to a depth of one fourth or more of the thickness of the plywood, and penetrate completely through the ceiling material.

The holes 20 provide the ceiling material with sound-absorbing performance. The size and shape of the holes can be formed in various ways.

For example, the holes with different sizes can be deployed in the ceiling material either repeatedly and regularly or irregularly. Since the hole with a small size and the hole with a large size can filter sound waves with different frequency bands, the ceiling material according to the present disclosure can provide sound-absorbing performance against sound waves in various bands. In addition, the ceiling material can have the depressions on the surface.

As to the ceiling material, the manufacturing methods described thus far can be referred to.

### Embodiment 1

7 mm-thick larch plywood was processed for having holes with a diameter of 4 mm (at an interval of 50 mm). The water-soluble incombustible resin was placed in vacuum for 10 min and infiltrated into the plywood at a pressure of 18 kgf/cm² for 2 hours.

### COMPARATIVE EXAMPLE 1

7 mm-thick larch plywood without perforation was infiltrated with the incombustible resin in vacuum in the same conditions as employed in Embodiment 1.

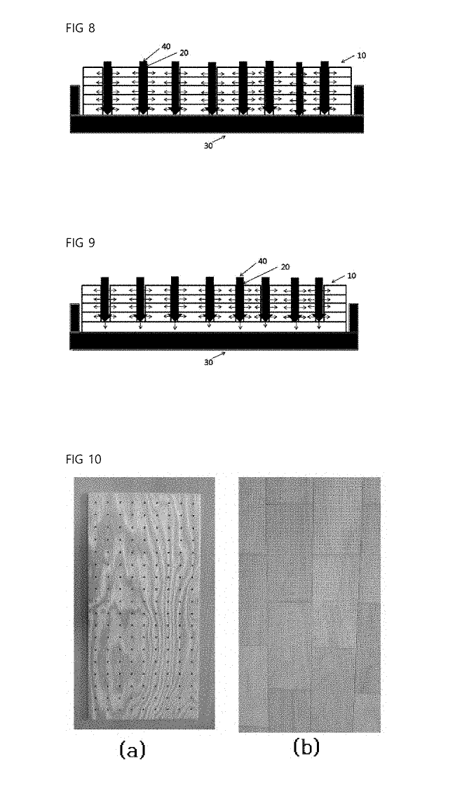

Table 1 shows the results of weight of the resin infiltrated in Embodiment 1 and Comparative Example 1. FIG. 10 shows the plywood ceiling material manufactured according to Embodiment 1, (a), and a construction example of the ceiling material of (a) adhered to the ceiling, (b).

TABLE 1

| | Weight | Weight | | |
|---|---|---|---|---|
| | before | after | Weight | Weight |
| | processing | processing | infiltrated | percent |
| Plywood | (g) | (g) | (kg/m³) | gain (%) |
| Comparative | 403.5 | 647.5 | 396.1 | 60.5 |
| Example 1 | | | | |
| Embodiment 1 | 363.0 | 664.5 | 489.5 | 83.1 |

It is shown infiltration of the incombustible resin increased by about 23% in Embodiment 1 in comparison with Comparative Example 1. Table 2 shows evaluation results of quasi-noncombustibility in Embodiment 1 and Comparative Example 1.

TABLE 2

| | Gross heat release (MJ/m²) | | | |
|---|---|---|---|---|
| | Measurement | Measurement | Measurement | Mean |
| Plywood | 1 | 2 | 3 | (MJ/m²) |
| Comparative | 35.4 | 32.8 | 32.3 | 33.5 |
| Example 1 | | | | |
| Embodiment 1 | 17.8 | 19.4 | 17.8 | 18.3 |

Table 2 shows incombustibility performance increases greatly in Embodiment 1 in comparison with Comparative Example 1.

### Embodiment 2

11 mm-thick larch plywood was processed for having holes with a diameter of 4 mm. The water-soluble incombustible resin was placed in vacuum for 10 min and infiltrated into the plywood at a pressure of 18 kgf/cm² for 2 hours.

Tables 3 and 4 show amount of the resin infiltrated and its quasi-noncombustibility performance of Embodiment 2. The performance test was referred to Korea Conformity Laboratories and they carried out the test according to KS F ISO 5660-1 (Jun. 8, 2015).

TABLE 3

| | Weight | Weight | | |
|---|---|---|---|---|
| | before | after | Weight | Weight |
| | processing | processing | infiltrated | percent |
| Plywood | (g) | (g) | (kg/m³) | gain (%) |
| Embodiment 2 | 533.5 | 1,081.5 | 541.5 | 102.7 |

TABLE 4

| | Gross heat release (MJ/m²) | | | |
|---|---|---|---|---|
| | Measurement | Measurement | Measurement | Mean |
| Plywood | 1 | 2 | 3 | (MJ/m²) |
| Embodiment 2 | 5.8 | 4.4 | 5.0 | 5.06 |

It is commonly known larch has very low infiltration performance of the resin and that an amount of an agent and the resin more than a reference value cannot be infiltrated into larch. However, it is verified the quasi-noncombustible ceiling material can be manufactured by using the plywood made of larch according to the methods of the present disclosure as shown in Tables 3 and 4.

### Embodiment 3

Flame radiance performance of 11 mm-thick hinoki cypress plywood was evaluated according to amount of the incombustible resin (g/m²) applied on the surface of the plywood.

Table 5 shows flame-retardancy performance according to the amount applied to the surface of the plywood of Embodiment 3 and the criteria provided by the National Fire Agency. As listed in Table 5, application amounts of the incombustible resin from 0 to 30 g/m² on the plywood surface failed; amounts from 60 to 90 g/m² passed but with boundary values of the acceptance criteria, which implies it may not proper to determine they show adequate flame-retardancy performance; and amounts of 120 g/m² or more adequately meet the performance criteria.

The present disclosure can be used for the flame-retardant and incombustible ceiling materials and, in particular, replace inorganic ceiling materials including gypsum board, which contains asbestos, and the like.

The present disclosure can be simply changed or modified by a person skilled in the art and such change or modification should be regarded as being included in the scope of right of the present disclosure.

What is claimed is:

1. A manufacturing method of incombustible and quasi-noncombustible ceiling materials comprising the steps of:
perforating plywood to form a plurality of holes;
transferring the perforated plywood to a vacuum chamber;
injecting water-soluble phosphorus-based incombustible resin into the vacuum chamber by reducing pressure inside the vacuum chamber, thereby keeping the inside of the vacuum chamber in vacuum;
infiltrating the incombustible resin into the plywood through the holes by applying a certain degree of pressure into the vacuum chamber filled with the incombustible resin; and
drying the plywood infiltrated with the resin.

2. A manufacturing method of incombustible and quasi-noncombustible ceiling materials comprising the steps of:
making depressions on the plywood;
transferring the plywood with the depressions to the vacuum chamber;
injecting the incombustible resin into the inside of the vacuum chamber by reducing pressure inside the vacuum chamber, thereby keeping the inside of the vacuum chamber in vacuum;
infiltrating the incombustible resin into the plywood by applying a certain degree of pressure into the vacuum chamber filled with the incombustible resin; and
drying the plywood infiltrated with the resin.

3. The manufacturing method of incombustible and quasi-noncombustible ceiling materials of claim 1, wherein, in the step of perforating, the holes are formed to penetrate through the plywood or have a depth of one fourth or more of the thickness of the plywood.

4. The manufacturing method of incombustible and quasi-noncombustible plywood ceiling materials of claim 1, wherein the holes have a diameter of 1 to 10 mm and are formed at an interval of 30 to 100 mm therein between.

5. The manufacturing method of incombustible and quasi-noncombustible plywood ceiling materials of claim 1, wherein, in the step of infiltrating, 15 kg/cm² or more of pressure is maintained inside the vacuum chamber.

6. An incombustible and quasi-noncombustible ceiling material comprising:
a plywood having a plurality of holes or depressions on the surface; and
incombustible resin infiltrated into the inside of the plywood through the holes.

7. The incombustible and quasi-noncombustible ceiling material of claim 6, comprising the holes which have a diameter of 1 to 10 mm and are formed at an interval of 30 to 100 mm therein between.

8. The incombustible and quasi-noncombustible ceiling material of claim 6, wherein the holes have a depth of one fourth or more of the thickness of the plywood.

9. A manufacturing method of flame-retardant plywood ceiling materials comprising the steps of:
drying and polishing the surface of the manufactured plywood;
coating the water-soluble phosphorus-based incombustible resin on the surface of the plywood; and
letting the applied resin permeate the surface layer of veneers and be dried,
wherein the dried plywood meets criteria for flame-retardancy performance.
